(19) United States
(12) Patent Application Publication
(10) Pub. No.: US 2014/0199593 A1
(43) Pub. Date: Jul. 17, 2014

(54) NEGATIVE ELECTRODE FOR NONAQUEOUS ELECTROLYTE SECONDARY BATTERY, NONAQUEOUS ELECTROLYTE SECONDARY BATTERY AND BATTERY PACK

(71) Applicant: KABUSHIKI KAISHA TOSHIBA, Tokyo (JP)

(72) Inventors: Yasuyuki HOTTA, Tokyo (JP); Takashi KUBOKI, Tokyo (JP); Tomokazu MORITA, Chiba (JP)

(73) Assignee: KABUSHIKI KAISHA TOSHIBA, Tokyo (JP)

(21) Appl. No.: 14/211,831

(22) Filed: Mar. 14, 2014

Related U.S. Application Data
(63) Continuation of application No. PCT/JP2012/057434, filed on Mar. 23, 2012.

(51) Int. Cl. H01M 4/133

(52) U.S. Cl. CPC H01M 4/133
USPC 429/217

(57) ABSTRACT

A negative electrode for a nonaqueous electrolyte secondary battery has a current collector, a negative electrode active material layer containing a negative electrode active material and a binder that binds the negative electrode active material, and an azole compound having an amino group as a functional group at a part of an interface between the negative electrode active material layer and the current collector.

### CROSS-REFERENCE TO RELATED APPLICATION

This application is a continuation application based upon and claims the benefit of priority from International Application PCT/JP2012/057434, the International Filing Date of which is Mar. 23, 2012 the entire contents of which are incorporated herein by reference.

### FIELD

Embodiments described herein relate generally to a negative electrode for a nonaqueous electrolyte secondary battery, a nonaqueous electrolyte secondary battery and a battery pack.

### BACKGROUND

In recent years, various portable electronic devices have become widespread due to rapid development of techniques for downsizing electronics devices. Batteries as power supplies of these portable electronic devices are required to be downsized, and nonaqueous electrolyte secondary batteries having a high energy density receive attention.

Particularly, attempts have been made to use substances having a high lithium storage capacity and a high density, such as elements that form an alloy with silicon or tin, and amorphous chalcogen compounds. Among them, silicon is capable of storing lithium at a ratio of up to 4.4 lithium atoms per silicon atom, and has a negative electrode capacity per mass which is about 10 times as high as that of graphitic carbon. However, silicon undergoes a significant change in volume associated with insertion and desorption of lithium in a charge-discharge cycle, and has a problem in life cycle due to size reduction of active material particles or the like.

The inventors have extensively conducted experiments, and resultantly found that when fine silicon monoxide and a carbonaceous substance are compounded and fired, an active material is obtained in which microcrystalline Si is dispersed in a carbonaceous substance while being included in or held by SiO₂ which is strongly bound with Si, so that capacity enhancement and improvement of cycle characteristics can be achieved. However, even with such an active material, the capacity decreases when several hundred charge-discharge cycles are performed, and therefore life characteristics are not sufficient for a long time of use.

Further, as a result of conducting close studies on a process of decrease in capacity, it has been found that microcrystalline Si is grown while charge-discharge is repeated, so that the crystallite size is increased. The problem is that due to the growth of the crystallite size, influences of a change in volume associated with insertion and desorption of Li during charge-discharge become significant, leading to a decrease in capacity.

### BRIEF DESCRIPTION OF THE DRAWINGS

FIG. 1 is a conceptual view of a negative electrode active material of an embodiment;

FIG. 2 is a conceptual view of a nonaqueous electrolyte secondary battery of an embodiment;

FIG. 3 is an enlarged conceptual view of a nonaqueous electrolyte secondary battery of an embodiment;

FIG. 4 is a conceptual view of a battery pack of an embodiment; and

FIG. 5 is a block diagram illustrating an electric circuit of a battery pack.

### DETAILED DESCRIPTION

A negative electrode for a nonaqueous electrolyte secondary battery of an embodiment comprises a current collector, a negative electrode active material layer containing a negative electrode active material and a binder that binds the negative electrode active material, and an azole compound having an amino group as a functional group at a part of an interface between the negative electrode active material layer and the current collector.

A nonaqueous electrolyte secondary battery of an embodiment comprises a negative electrode. The negative electrode includes a current collector, a negative electrode active material layer containing a negative electrode active material and a binder that binds the negative electrode active material, and an azole compound having an amino group as a functional group at apart of an interface between the negative electrode active material layer and the current collector.

A battery pack of an embodiment comprises a nonaqueous electrolyte secondary battery. The nonaqueous electrolyte secondary battery comprises a negative electrode. The negative electrode includes a current collector, a negative electrode active material layer containing a negative electrode active material and a binder that binds the negative electrode active material, and an azole compound having an amino group as a functional group at a part of an interface between the negative electrode active material layer and the current collector.

Embodiments will be described below with reference to the drawings.

### First Embodiment

As illustrated in the conceptual view of FIG. 1, a negative electrode 100 of the first embodiment includes a current collector 104, a negative electrode active material layer 103 containing a negative electrode active material 101 and a binder 102 that binds the negative electrode active material 101, and an azole compound 105 having an amino group as a functional group, which bonds the negative electrode active material layer 103 and the current collector 104, at a part of an interface between the negative electrode active material layer 103 and the current collector 104. The negative electrode active material layer 103 is formed on one or both of the surfaces of the current collector 104.

The negative electrode active material 101 of the embodiment is an active material containing crystalline silicon which inserts and desorbs Li. Specific examples of the negative electrode active material 101 include composite particles having a silicon oxide phase in a carbonaceous substance and a silicon phase in the silicon oxide phase. The silicon oxide phase of the negative electrode active material in this form is dispersed in the carbonaceous substance and compounded with the carbonaceous substance. The silicon phase is dispersed in the silicon oxide phase and compounded with silicon oxide phase.

The negative electrode active material is particles having an average primary particle diameter of, for example, 5 μm to 100 μm (inclusive) and a specific surface area of 0.5 m²/g to 10 m²/g (inclusive). The particle diameter and the specific surface area of the active material affect the speed of an insertion and desorption reaction of lithium, and has significant influences on negative electrode characteristics, but as long as the average primary particle diameter and the specific surface area fall within the above-mentioned ranges, characteristics can be stably exhibited.

The carbonaceous substance shown as an example is conductive, and forms an active material. As the carbonaceous substance, at least one selected from the group consisting of graphite, hard carbon, soft carbon, amorphous carbon and acetylene black can be used.

The silicon oxide phase shown as an example alleviates expansion and contraction of the silicon phase. Examples of the silicon oxide phase include compounds having an amorphous structure, a low-crystalline structure, a crystalline structure or the like and represented by the chemical formula of SiOₓ (1<x≦2)

The silicon phase expands and contracts as Li is inserted and desorbed. When the phase is bound to increase the size of the phase with the expansion and contraction, cycle characteristics tend to be deteriorated. For preventing deterioration of cycle characteristics, it is preferred to take measures such as micronization of the silicon phase and uniformalization of the size of the phase, micronization of the silicon oxide phase and uniformalization of the size of the phase, addition of cubic zirconia and addition of carbon fibers.

The binder 102 of the embodiment is a material that is excellent in property of binding negative electrode active materials and excellent in property of binding the negative electrode active material layer 103 and the current collector 104. As the binder 102, for example, polytetrafluoroethylene (PTFE), polyvinylidene fluoride (PVdF), an ethylene-propylene-diene copolymer (EPDM), styrene-butadiene rubber (SBR), polyimide, polyaramide or the like can be used. For the binder, two or more substances may be used in combination, and when a combination of a binder excellent in binding of active materials and a binder excellent in binding of an active material and a current collector, or a combination of a binder having a high hardness and a binder excellent in flexibility is used, a negative electrode excellent in life characteristics can be prepared.

The negative electrode active material layer 103 is a mixture containing the negative electrode active material 101 and the binder 102. In addition to the negative electrode active material 101 and the binder 102, a conducting agent may be added to the negative electrode active material layer 103 for the purpose of improving conductivity of the negative electrode. Examples of the conducting agent may include acetylene black, carbon black and graphite. The thickness of the negative electrode active material layer 103 is desired to be in a range of 1.0 to 150 μm. Therefore, the total thickness of the negative electrode active material layer 103 is in a range of 2.0 to 300 μm when the negative electrode active material layer 103 is carried on both the surfaces of the negative electrode current collector 104. The thickness on one surface is more preferably in a range of 30 to 100 μm. When the thickness is in this range, large current discharge characteristics and the cycle life are considerably improved.

The blending ratio of the negative electrode active material, the conducting agent and the binder is preferably in a range of 57 to 95% by mass for the negative electrode active material, 3 to 20% by mass for the conducting agent and 2 to 40% by mass for the binder because proper large current discharge characteristics and a proper cycle life can be obtained.

The current collector 104 of the embodiment is a conductive member to be bound with the negative electrode active material layer 103. For the current collector 104, a conductive board of porous structure or a nonporous conductive board can be used. Such a conductive board can be formed from, for example, copper, stainless steel or nickel. The thickness of the current collector is desired to be 5 to 20 μm. This is because when the thickness is in this range, a balance can be maintained between the electrode strength and weight reduction.

The azole compound 105 having an amino group as a functional group in this embodiment is a joining member which is present at a part of an interface between the negative electrode active material layer 103 and the current collector 104 and bonds the negative electrode active material layer 103 and the current collector 104 to each other. The azole compound 105 has a higher binding strength with the surface of a metal such as Cu as compared to general binders, and is excellent in affinity with a binder having a polar group because it has an amino group, so that the azole compound 105 acts to improve adhesion between the negative electrode active material layer 103 and the current collector 104 and prevent peeling associated with insertion and desorption of Li. The azole compound 105 is present at an interface between the negative electrode active material layer 103 and the current collector 104 in the form of a film in which a plurality of molecules are agglomerated or in a state in which single molecules are independent of one another.

As the azole compound 105, an azole compound having an amino group as a functional group can be used. The azole compound 105 is a compound having an amino group as a functional group and having an azole ring, and examples of the azole ring include, but are not limited to, at least one compound selected from the group of diazole, oxazole, triazole, triazole, oxadiazole, thiadiazole, tetrazole, oxatriazole and thiatriazole. Among the above-mentioned azole compounds, a tetrazole compound is preferred because it has a high capability of forming a complex with a metal such as Cu. The azole compound 105 having an amino group as a functional group has proper affinity with a binder as compared to an azole compound having no amino group, and when a polyimide precursor is used for the binder, a reaction takes place in an imidization process, so that a higher binding strength is exhibited.

Specific examples of the azole compound 105 include, but are not limited to, azole compounds having two to four nitrogen atoms in a ring, such as 2-aminobenzoimidazole, 3-amino-1,2,4-triazole, 4-amino-1,2,4-triazole, 3,5-diamino-1,2,4-triazole, 3-amino-1,2,4-triazole-5-carboxylic acid, 2,5-bis(4-aminophenyl)-1,3,4-oxadiazole, 5-amino-1H-tetrazole, 1-(β-aminoethyl)tetrazole, 5-amino-1,2,3,4-thiatriazole, 2-amino-5-trifluoromethyl-1,3,4-thiadiazole, 5-aminoindazole, 4-aminoindole, 5-aminoindole, 3-amino-1H-isoindole, 3-aminoisoxazole, 3-β-aminoethylpyrazole, 3-amino-1,2,4-triazole, 4-amino-1,2,4-triazole, 3,5-diamino-1,2,4-triazole, 3-amino-1,2,4-triazole-5-carboxylic acid, 5-aminotetrazole and 1-(β-aminoethyl)tetrazole, and the azole compounds maybe used alone or maybe used in combination of two or more thereof.

The azole compound 105 is present in a range of 5% to 95% (inclusive) of the area of an interface (surface of the current collector 104 provided with the negative electrode active material layer 103). When the area in which the azole compound 105 is present is below the above-mentioned range, little peel resistance improving effect is obtained. Since the azole compound 105 has poor conductivity, it is not preferred that the area in which the azole compound 105 is present exceeds the above-mentioned range because conductivity between the negative electrode active material layer 103 and the current collector is reduced.

The interface area of the azole compound can be easily determined in the following manner: for a surface treated Cu foil current collector, the surface of the Cu foil is measured under conditions including an acceleration voltage of 10 kV and an emission current of 10.0 μA by using an energy dispersive X-ray spectrometer (EDX), and element mapping is performed.

Presence of the azole compound at an interface between the negative electrode active material layer 103 and the current collector 104 can be known by analyzing the negative electrode from the negative electrode active material layer 103 side by an attenuated total reflection method in infrared spectroscopic analysis, and observing an absorption spectrum at 3400 cm⁻¹ originating from an amino group and an absorption spectrum at 1640 cm⁻¹ specific to the azole compound 105.

Presence of the azole compound 105 can also be easily known by immersing the current collector 104, from which the negative electrode active material layer 103 is removed, in methanol to extract the azole compound, and carrying out a method that is commonly employed in the art for organic spectroscopic analysis such as LC/MS and GC/MS. In the constitution of the present invention, at this time it can also be confirmed that the azole compound is not detected by subjecting a part of the negative electrode active material layer 103, which extends from the surface downward to about ⅓ of the thickness, to MS spectroscopic analysis using a similar methanol extraction method.

Next, a method for production of the negative electrode 100 of the embodiment will be described.

The negative electrode 100 can be easily formed by preparing a solution with the azole compound 105, which has an amino group as a functional group, dissolved in an organic solvent (hereinafter, referred to as a surface treating liquid) and treating the surface of the current collector 104 therewith. In this case, the surface treating liquid and the surface of the current collector 104 should be in contact with each other over the entire treatment surface, and the method thereof is not limited, but preferably they are brought into uniform contact with each other. The current collector 104 may be immersed in the surface treating liquid, or the surface treating liquid may be sprayed to a copper foil using a spray, or may be applied to a board using an appropriate tool. The temperature of the surface treating liquid at this time is preferably 0 to 100° C., more preferably 10 to 80° C. The treatment can be performed in consideration of a boiling point, a vapor pressure and the like of an organic solvent to be used.

Examples of the solvent that can be used to dissolve the azole compound 105 include, but are not limited to, hydrocarbon-based alcohols, for example methanol, ethanol, propanol, isopropanol, butanol, tert-butanol, pentanol, hexanol, heptanol and octanol, hydrocarbon-based ketones, for example acetone, propanone, methyl ethyl ketone, methyl isobutyl ketone and cyclohexanone, hydrocarbon-based ethers, for example diethyl ether, ethylene glycol dimethyl ether, diethylene glycol dimethyl ether and tetrahydrofuran, hydrocarbon-based esters, for example methyl acetate, ethyl acetate, butyl acetate and γ-butyrolactone, and others, for example toluene, xylene, dimethylformamide, dimethylacetamide, dimethyl sulfoxide dichloromethane, chloroform, carbon tetrachloride and dichloroethane.

The concentration of the azole compound 105 in the surface treating liquid is preferably 0.001 to 1 mol/l, and is preferably low for reducing excessive deposition of the azole compound 105, but when the concentration is excessively low, the effect of improving bonding strength between the current collector 104 and the negative electrode active material layer 103 is lost, and therefore the concentration is more preferably 0.01 to 0.5 mol/l.

After the above-described treatment, a washing step of dissolving and removing the azole compound 105 excessively deposited on the surface of the current collector 104 using an organic solvent. As the organic solvent to be used in this washing, a solvent capable of dissolving the azole compound 105 can be used. As an example, the organic solvents described above can be used.

The method for washing the surface of the current collector 104 with an organic solvent in the washing step is not limited. The current collector may be immersed in the solvent, or the excessive azole compound may be washed off by spraying the solvent using a spray, or may be wiped off with an appropriate base material soaked with the solvent. For removing the washing liquid, a drying step at about 100° C. or lower maybe applied. This step may employ any method such as hot air drying, drying in an oven or drying on a hot plate.

Next, the negative electrode active material, the conducting agent and the binder are suspended in a commonly used solvent to prepare a slurry. The slurry is applied to the current collector 104 treated with the azole compound 105, and dried, followed by performing pressing to prepare a negative electrode.

### Second Embodiment

A nonaqueous electrolyte secondary battery according to the second embodiment will be described.

The nonaqueous electrode secondary battery according to the second embodiment includes an exterior material, a positive electrode stored in the exterior material, a negative electrode containing an active material, the negative electrode stored so as to be spatially separated from the positive electrode, e.g. with a separator interposed therebetween, in the exterior material, and a nonaqueous electrolyte filled in the exterior material.

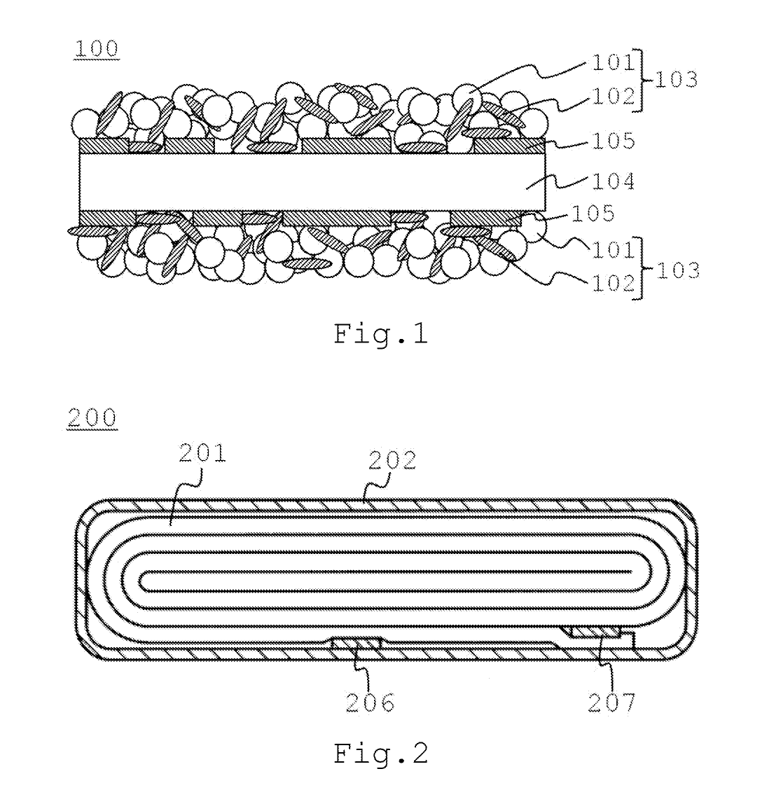

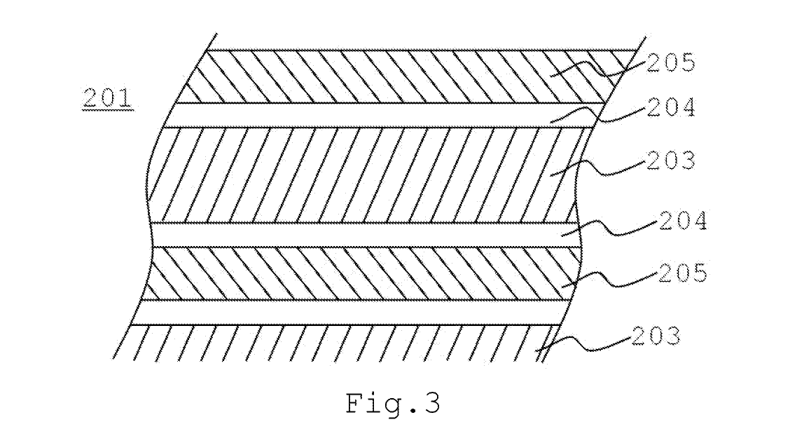

The nonaqueous electrolyte secondary battery will be described more in detail with reference to the conceptual views of FIG. 2 that illustrate a nonaqueous electrolyte secondary battery 200 according to the embodiment. FIG. 2 is a conceptual sectional view of the flat-type nonaqueous electrolyte secondary battery 200 with a bag-shaped exterior material 202 formed of a laminate film.

A flat winding electrode group 201 is stored in the bag-shaped exterior material 202 formed of a laminate film with an aluminum foil interposed between two resin layers. The flat winding electrode group 201 has a negative electrode 203, a separator 204, a positive electrode 205 and the separator 204 stacked in this order as illustrated in FIG. 3, a conceptual view showing a part of the winding electrode group 201. The flat winding electrode group 201 is formed by winding the stacked product in a coiled manner and performing press-molding. The electrode closest to the bag-shaped exterior material 202 is the negative electrode, and the negative electrode has a configuration in which a negative electrode mixture is formed only on one surface of the negative electrode current collector on the battery inner surface side with no negative electrode mixture formed on the negative electrode current collector on the bag-shaped exterior material 202 side. The other negative electrode 203 is configured such that the negative electrode mixture is formed on each of both surfaces of the negative electrode current collector. The positive electrode 205 is configured such that a positive electrode mixture is formed on each of both surfaces of a positive electrode current collector.

In the vicinity of the outer peripheral of the winding electrode group 201, a negative electrode terminal is electrically connected to the negative electrode current collector of the negative electrode 203 at the outermost shell, and a positive electrode terminal is electrically connected to the positive electrode current collector of the positive electrode 205 on the inner side. The negative electrode terminal 206 and positive electrode terminal 207 are protruded to the outside from an opening of the bag-shaped exterior material 202. For example, a liquid nonaqueous electrolyte is injected from the opening of the bag-shaped exterior material 202. The opening of the bag-shaped exterior material 202 is heat-sealed with the negative electrode terminal 206 and the positive electrode terminal 207 sandwiched therein to completely seal the winding electrode group 201 and the liquid nonaqueous electrolyte.

The negative electrode terminal 206 includes, for example, aluminum or an aluminum alloy containing elements such as Mg, Ti, Zn, Mn, Fe, Cu and Si. Preferably the negative electrode terminal 206 is formed of a material similar to that of the negative electrode current collector for reducing the contact resistance with the negative electrode current collector.

For the positive electrode terminal 207, a material having electrical stability at an electric potential of 3 to 4.25 V to a lithium ion metal, and conductivity can be used. Specific examples include aluminum and aluminum alloys containing elements such as Mg, Ti, Zn, Mn, Fe, Cu and Si. Preferably the positive electrode terminal 207 is formed of a material similar to that of the positive electrode current collector for reducing the contact resistance with the positive electrode current collector.

The bag-shaped exterior material 202, the positive electrode 205, the electrolyte and the separator 204, which are constituent members of the nonaqueous electrolyte secondary battery 200, will be described in detail below.

1) Bag-Shaped Exterior Material 202

The bag-shaped exterior material 202 is formed of a laminate film having a thickness of 0.5 mm or less. Alternatively, for the exterior material, a metallic container having a thickness of 1.0 mm or less is used. More preferably the metallic container has a thickness of 0.5 mm or less.

The shape of the bag-shaped exterior material 202 can be selected from a flat type (thin type), a rectangular type, a cylindrical type, a coin type and a button type. Examples of the exterior material include, depending on a battery size, exterior materials for small batteries that are mounted in portable electronic devices etc. and exterior materials for large batteries that are mounted in two to four-wheeled automobiles etc.

For the laminate film, a multilayer film with a metal layer interposed between resin layers is used. The metal layer is preferably an aluminum foil or an aluminum alloy foil for reduction of weight. For the resin layer, for example, a polymer material such as polypropylene (PP), polyethylene (PE), nylon or polyethylene terephthalate (PET) can be used. The laminate film can be formed into a shape of the exterior material by sealing the film by heat sealing.

The metallic container is made from aluminum, an aluminum alloy or the like. The aluminum alloy is preferably an alloy containing elements such as magnesium, zinc, silicon and the like. When transition metals such as iron, copper, nickel and chromium are contained in the alloy, the amount thereof is preferably 100 ppm by mass or less.

2) Positive Electrode 205

The positive electrode 205 has a structure in which the positive electrode mixture containing an active material is carried on one or both of the surfaces of the positive electrode current collector.

The thickness of the positive electrode mixture on one surface is desired to be in a range of 1.0 μm to 150 μm for retaining the large current discharge characteristics and cycle life of the battery. Therefore, the total thickness of the positive electrode mixture is desired to be in a range of 20 μm to 300 μm when it is carried on both the surfaces of the positive electrode current collector. The thickness on one surface is more preferably in a range of 30 μm to 120 μm. When the thickness is in this range, the large current discharge characteristics and cycle life are improved.

The positive electrode mixture may contain a conducting agent in addition to the positive electrode active material and the binder for binding positive electrode active materials.

Use of various kinds of oxides, for example manganese dioxide, a lithium manganese composite oxide, a lithium-containing nickel cobalt oxide (e.g. LiCOO₂), a lithium-containing nickel cobalt oxide (e.g. LiNi_{0.8}CO_{0.2}O₂) and a lithium manganese composite oxide (e.g. LiMn₂O₄ and LiMnO₂) as the positive electrode active material is preferred because a high voltage can be obtained.

Examples of the conducting agent may include acetylene black, carbon black and graphite.

As a specific example of the binder, polytetrafluoroethylene (PTFE), polyvinylidene fluoride (PVdF), an ethylene-propylene-diene copolymer (EPDM), styrene-butadiene rubber (SBR) or the like can be used.

The blending ratio of the positive electrode active material, the conducting agent and the binder is preferably in a range of 80 to 95% by mass for the positive electrode active material, 3 to 20% by mass for the conducting agent and 2 to 7% by mass for the binder because proper large current discharge characteristics and a proper cycle life can be obtained.

For the current collector, a conductive board of porous structure or a nonporous conductive board can be used. The thickness of the current collector is desired to be 5 to 20 μm. This is because when the thickness is in this range, a balance can be maintained between the electrode strength and weight reduction.

The positive electrode 205 is prepared by, for example, suspending an active material, a conducting agent and a binder in a commonly used solvent to prepare a slurry, applying the slurry to the current collector, drying the slurry and then performing pressing. The positive electrode 205 may also be prepared by forming an active material, a conducting agent and a binder into a pellet shape to obtain the positive electrode layer, and forming the positive electrode layer on the current collector.

3) Negative Electrode 203

As the negative electrode 203, the negative electrode 100 described in the first embodiment is used.

4) Electrolyte

As the electrolyte, a nonaqueous electrolyte solution, an electrolyte-impregnated-type polymer electrolyte, a polymer electrolyte or an inorganic solid electrolyte can be used.

The nonaqueous electrolyte solution is a liquid electrolyte solution prepared by dissolving an electrolyte in a nonaqueous solvent, and is held in voids in the electrode group.

As the nonaqueous solvent, it is preferred to use a nonaqueous solvent having as a principal component a mixed solvent of propylene carbonate (PC) or ethylene carbonate (EC) and a nonaqueous solvent having a viscosity lower than that of PC or EC (hereinafter, referred to as a second solvent).

As the second solvent, for example chain carbon is preferred, and examples thereof include dimethyl carbonate (DMC), methyl ethyl carbonate (MEC), diethyl carbonate (DEC), ethyl propionate, methyl propionate, γ-butyrolactone (BL), acetonitrile (AN), ethyl acetate (EA), toluene, xylene and methyl acetate (MA). These second solvents may be used alone or in the form of a mixture of two or more thereof. Particularly, more preferably the second solvent has a donor number of 16.5 or less.

The viscosity of the second solvent is preferably 2.8 cmp or less at 25° C. The blending amount of ethylene carbonate or propylene carbonate in the mixed solvent is preferably 1.0% to 80% in terms of a volume ratio. The blending amount of ethylene carbonate or propylene carbonate in the mixed solvent is more preferably 20% to 75% in terms of a volume ratio.

Examples of the electrolyte contained in the nonaqueous electrolyte solution include lithium salts (electrolytes) such as lithium perchlorate (LiClO₄), lithium hexafluorophosphate (LiPF₆), lithium borofluoride (LiBF₄), lithium hexafluoroarsenide (LiAsF₆), lithium trifluorometasulfonate (LiCF₃SO₃) and bistrifluoromethylsulfonylimide lithium [LiN(CF₃SO₂)₂]. Among them, it is preferred to use LiPF₆ or LIBF₄.

The amount of the electrolyte dissolved in the nonaqueous solvent is desired to be 0.5 to 2.0 mol/L.

5) Separator 204

When a nonaqueous electrolyte solution is used and when an electrolyte-impregnated-type polymer electrolyte is used, the separator 204 can be used. For the separator 204, a porous separator is used. As a material of the separator 204, for example, a porous film including polyethylene, polypropylene or polyvinylidene fluoride (PVdF), a synthetic resin nonwoven fabric, or the like can be used. Particularly, a porous film formed of polyethylene or polypropylene or both is preferred because safety of the secondary battery can be improved.

The thickness of the separator 204 is preferably 30 μm or less. When the thickness is more than 30 μm, the distance between positive and negative electrodes may become large, leading to an increase in internal resistance. The lower limit value of the thickness is preferably 5 μm. When the thickness is less than 5 μm, the strength of the separator 204 may be significantly reduced to cause an internal short-circuit to easily occur. The upper limit value of the thickness is more preferably 25 μm, and the lower limit value is more preferably 1.0 μm.

Preferably the separator 204 has a thermal shrinkage rate of 20% or less when left standing at 120° C. for 1 hour. When the thermal shrinkage rate is more than 20%, the possibility is increased that short-circuit occurs upon heating. The thermal shrinkage rate is more preferably 15% or less.

Preferably the separator 204 has a porosity of 30 to 70%. The reason for this is as follows. When the porosity is less than 30%, it may be difficult to achieve high electrolyte retainability in the separator 204. On the other hand, when the porosity is more than 60%, a sufficient strength of the separator 204 may not be achieved. The porosity is more preferably in a range of 35 to 70%.

Preferably the separator 204 has an air permeability of 500 seconds/100 cm³ or less. When the air permeability is more than 500 seconds/100 cm³, it may be difficult to achieve a high lithium ion mobility in the separator 204. The lower limit value of the air permeability is 30 seconds/100 cm³. This is because when the air permeability is less than 30 seconds/100 cm³, a sufficient separator strength may not be achieved.

The upper limit value of the air permeability is more preferably 300 seconds/100 cm³, and the lower limit value is more preferably 50 seconds/100 cm³.

### Third Embodiment

Next, a battery pack according to the third embodiment will be described.

The battery pack according to the third embodiment includes one or more nonaqueous electrolyte secondary batteries (i.e. single batteries) according to the second embodiment. When a plurality of single batteries is included in the battery pack, the single batteries are disposed so as to be electrically connected in series, in parallel, or in series and in parallel.

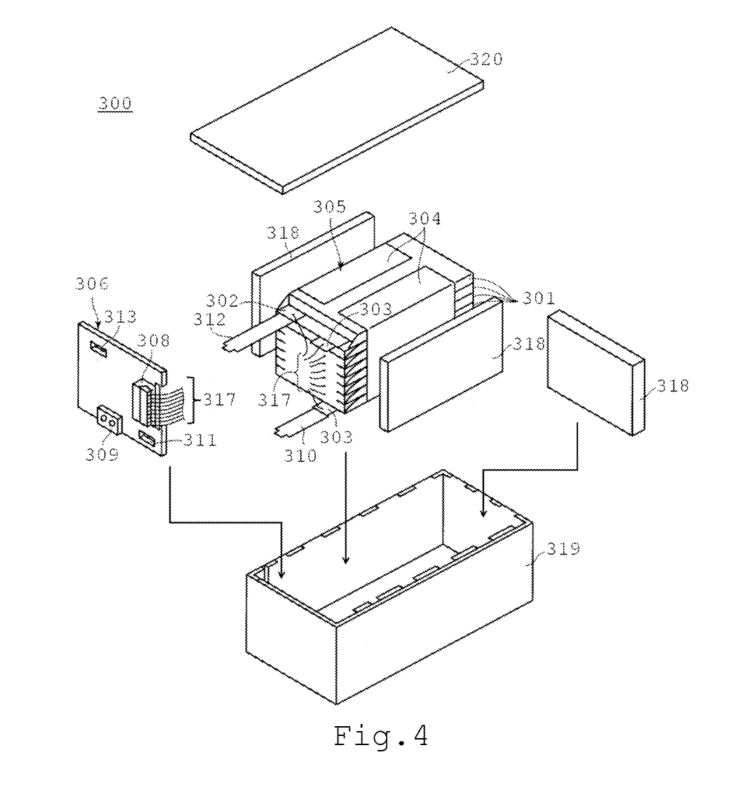

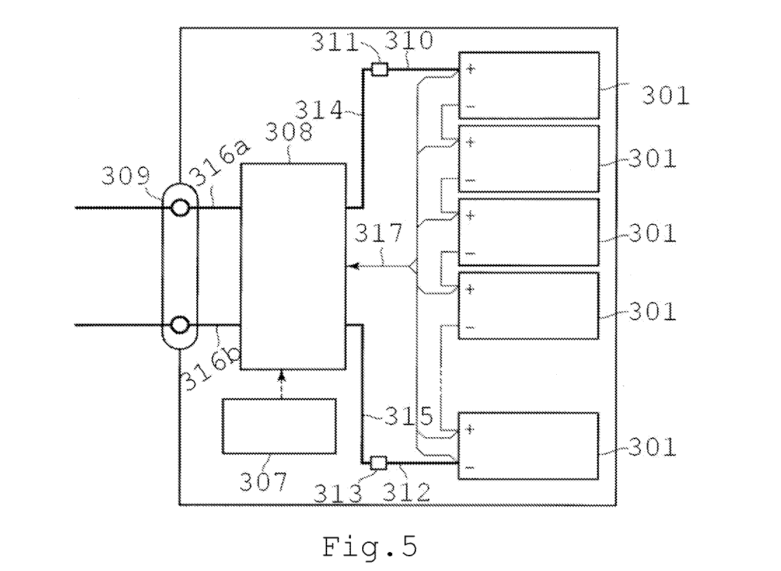

A battery pack 300 will be described in detail with reference to the conceptual view of FIG. 4 and the block diagram of FIG. 5. In the battery pack 300 illustrated in FIG. 4, a flat-type nonaqueous electrolyte secondary battery 200 shown in FIG. 2 is used as a single battery 301.

A plurality of single batteries 301 are stacked such that a negative electrode terminal 302 and a positive electrode terminal 303 which are protruded to the outside are aligned in the same direction, and the single batteries are fastened by an adhesive tape 304 to form an assembled battery 305. These single batteries 301 are mutually electrically connected in series as illustrated in FIG. 5.

A print wiring board 306 is disposed so as to face the side surface of the single battery 301 where the negative electrode terminal 302 and the positive electrode terminal 303 are extended. A thermistor 307, a protective circuit 308 and a terminal 309 for electric conduction to external devices are mounted on the print wiring board 306 as illustrated in FIG. 5. For avoiding unnecessary connection to wiring of the assembled battery 305, an insulation plate (not illustrated) is attached on a surface of the print wiring board 306 which faces the assembled battery 305.

A positive electrode-side lead 310 is connected to the positive electrode terminal 303 positioned at the lowermost layer of the assembled battery 305, and its tip is inserted into a positive electrode-side connector 311 of the print wiring board 306 to be electrically connected thereto. A negative electrode-side lead 312 is connected to the negative electrode terminal 302 positioned at the uppermost layer of the assembled battery 305, and its tip is inserted into a negative electrode-side connector 313 of the print wiring board 306 to be electrically connected thereto. The connectors 311 and 313 are connected to the protective circuit 308 through wirings 314 and 315 formed on the print wiring board 306.

The thermistor 307 is used for detecting a temperature of the single battery 305, and a detection signal thereof is sent to the protective circuit 308. The protective circuit 308 can disconnect positive-side wiring 316a and negative-side wiring 316b between the protective circuit 308 and the terminal 309 for electric conduction to external devices at a predetermined condition. The predetermined condition means a time when the detected temperature of, for example, the thermistor 307 reaches a temperature equal to or higher than a predetermined temperature. Further, the predetermined condition means a time when overcharge, overdischarge, overcurrent or the like of the single battery 301 is detected. The detection of overcharge etc. is performed on individual single batteries 301 or the whole of single batteries 301. When detection is performed on individual single batteries 301, a battery voltage may be detected, or a positive electrode potential or a negative electrode potential may be detected. In the latter case, a lithium electrode to be used as a reference electrode is inserted into each of individual single batteries 301. In the case of FIGS. 4 and 5, wiring 317 for voltage detection is connected to each of single batteries 301, a detection signal is sent to the protective circuit 308 through the wiring 317.

A protective sheet 318 formed of rubber or resin is disposed on each of three side surfaces of the assembled battery 305 which do not include a side surface where the positive electrode terminal 303 and the negative electrode terminal 302 are protruded.

The assembled battery 305 is stored in a storage container 319 together with the protective sheets 318 and the print wiring board 306. That is, the protective sheet 318 is disposed on each of both inner side surfaces of the storage container 319 in the long side direction and an inner side surface of the storage container 319 in the short side direction, and the print wiring board 306 is disposed on an inner side surface on the opposite side in the short side direction. The assembled battery 305 is positioned in a space surrounded by protective sheets 318 and the print wiring board 306. A lid 320 is mounted on the upper surface of the storage container 319.

For fixation of the assembled battery 305, a thermally shrinkable tape may be used in place of the adhesive tape 304. In this case, a protective sheet is disposed on each of both side surfaces of the assembled battery, a thermally shrinkable tape is wound, and the thermally shrinkable tape is then thermally shrunk to bind the assembled battery.

FIGS. 4 and 5 illustrate a configuration in which single batteries 301 are connected in series, but for increasing the battery capacity, single batteries 301 may be connected in parallel, or connection in series and connection in parallel may be combined. Assembled battery packs can also be further connected in series or in parallel.

According to the embodiment described above, there can be provided a battery pack which includes a nonaqueous electrolyte secondary battery having excellent charge-discharge cycle performance in the third embodiment and therefore has excellent charge-discharge cycle performance.

The aspect of the battery pack is appropriately changed according to an application. Battery packs to be applied are preferably those that exhibit excellent cycle characteristics when a large current is extracted. Specific examples include those for power supplies of digital cameras and those to be mounted on vehicles such as two to four wheeled hybrid electric cars, two to four wheeled electric cars and assisted bicycles. Particularly, battery packs using a nonaqueous electrolyte secondary battery excellent in high temperature characteristics are suitably used for vehicle-mounting applications.

Hereinafter, specific examples (examples of specifically preparing the battery described in FIG. 2 under respective conditions described in examples) will be shown, and effect thereof will be described.

### EXAMPLE 1

Grinding of SiO, mixing and kneading and formation of a composite, and firing in an Ar gas were performed in the following conditions to obtain a negative electrode active material.

SiO was ground in the following manner. A raw material SiO powder was subjected to a grinding treatment for a predetermined time with ethanol as a dispersion medium using beads having a bead diameter of 0.5 μm in a continuous bead mill apparatus. Further, the SiO powder was ground with ethanol as a dispersion medium using balls of 0.1 μm in a planetary ball mill, thereby preparing a SiO fine powder.

The silicon monoxide powder obtained by the finely grinding treatment and a graphite powder of 6 μm were compounded with hard carbon by the following method. To a mixed liquid of 4.0 g of furfuryl alcohol, 10 g of ethanol and 0.125 g of water were added 2.3 g of the SiO powder, 0.7 g of the graphite powder and 0.06 g of carbon fibers having an average diameter of 180 nm, and the mixture was subjected to a mixing/kneading treatment in a kneader to form a slurry. 0.2 g of dilute hydrochloric acid as a polymerization catalyst for furfuryl alcohol was added to the slurry after mixing/kneading, and the mixture was left standing at room temperature, dried, and solidified to obtain a carbon composite. The obtained carbon composite was fired in an Ar gas at 1050° C. for 3 hours, cooled to room temperature, and sieved over a screen with a mesh size of 30 μm to obtain a negative electrode active material.

A copper foil with the surface subjected to the following treatment was used as a current collector.

For removing a surface oxide film of the untreated electrolytic copper foil that was not surface-treated, the copper foil was immersed in a 10% aqueous hydrochloric acid solution for 60 seconds. For removing the deposited acid, the copper foil was sufficiently washed with ion-exchanged water, and dried by spraying compressed nitrogen. A treating liquid with 50 mg of 2-aminobenzoimidazole dissolved in 1 L of ethanol was uniformly sprayed over a spray onto the copper foil thus treated, and compressed nitrogen was then sprayed to dry the surface. Then, for washing off excessive 2-aminobenzoimidazole deposited on the copper foil surface, the copper foil was immersed in methanol for 60 seconds to wash the copper foil, and compressed nitrogen was thereafter sprayed to dry the surface, thereby obtaining a surface-treated copper foil, which was used as a current collector. When the surface of the surface-treated copper foil was evaluated at several random points by an ATR method, a peak originating from an amino group was observed at around 3400 cm⁻¹ to confirm that the 2-aminobenzoimidazole treatment could be completed as expected. As a result of element mapping by EDX, deposition of nitrogen in a ratio of average 83% was observed in a 100 μm visual field region.

The active material and current collector obtained in Example 1 were used to prepare a negative electrode, a charge-discharge test described below, i.e. a charge-discharge test using a cylindrical cell (FIG. 2) was conducted to evaluate charge-discharge characteristics.

(Charge-Discharge Test)

The obtained sample was mixed/kneaded with 15% by mass of graphite having an average diameter of 6 μm and 8% by mass of polyimide using N-methylpyrrolidone as a dispersion medium, the mixture was applied to a copper foil having a thickness of 12 μm, and the coated copper foil was rolled, heat-treated in an Ar gas at 250° C. for 2 hours, cut into a predetermined size, and then dried under vacuum at 100° C. for 12 hours to obtain a test electrode. A battery using metal Li for a counter electrode and a reference electrode and an EC/DEC (volume ratio of EC:DEC=1:2) solution of LiPF₆ (1 M) as an electrolyte solution was prepared in an argon atmosphere, and a charge-discharge test was conducted. For conditions for the charge-discharge test, the battery was charged at a current density of 1 mA/cm² up to a potential difference of 0.01 V between the reference electrode and the test electrode, further charged with a constant voltage at 0.01 V for 16 hours, and discharged at a current density of 1 mA/cm² up to 1.5 V. Further, a cycle including charging the battery at a current density of 1 mA/cm² up to a potential difference of 0.01 V between the reference electrode and the test electrode and discharging the battery at a current density of 1 mA/cm² up to 1.5 V was conducted 100 times, and a retention rate of the discharge capacity at the 100th cycle to that in the first cycle was measured.

Results for the following examples and comparative example are summarized in Table 1. The following examples and comparative example are described only for matters that are different from Example 1, and other synthesis and evaluation procedures are similar to those in Example 1, and therefore descriptions thereof are omitted.

### EXAMPLE 2

A copper foil was used where the azole compound used for surface treatment of the current collector changed to 5-amino-1H-tetrazole. When the surface of the surface-treated copper foil was evaluated at several random points by an ATR method, a peak originating from an amino group was observed at around 3400 cm⁻¹ and a peak originating from an azo group was observed at around 1640 cm⁻¹ to confirm that the 5-amino-1H-tetrazole treatment could be completed as expected. As a result of element mapping by EDX, deposition of nitrogen in a ratio of average 78% was observed in a 100 μm visual field region.

### COMPARATIVE EXAMPLE 1

A negative electrode was prepared in the same manner as in Example 1 using a surface-untreated copper foil as a current collector.

### COMPARATIVE EXAMPLE 2

A negative electrode mixture similar to that in Example 1 was provided.

A copper foil with the surface subjected to the following treatment was used as a current collector.

For removing a surface oxide film of the untreated electrolytic copper foil that was not surface-treated, the copper foil was immersed in a 10% aqueous hydrochloric acid solution for 60 seconds. For removing the deposited acid, the copper foil was sufficiently washed with ion-exchanged water, and dried by spraying compressed nitrogen. A treating liquid with 50 mg of 2-aminobenzoimidazole dissolved in 1 L of ethanol was uniformly sprayed over a spray onto the copper foil thus treated, and compressed nitrogen was then sprayed to dry the surface, thereby obtaining a surface-treated copper foil, which was used as a current collector. When the surface of the surface-treated copper foil was evaluated at several random points by an ATR method, a peak originating from an amino group was observed at around 3400 cm⁻¹ to confirm that the 2-aminobenzoimidazole treatment could be completed as expected. As a result of element mapping by EDX, deposition of nitrogen in a ratio of average 99% was observed in a 100 μm visual field region.

TABLE 1

| | DISCHARGE | CAPACITY RETENTION |
|---|---|---|
| | CAPACITY | RATE [%] |
| | [mAh/g] | AFTER 100 CYCLES |
| Example 1 | 874 | 91 |
| Example 2 | 876 | 93 |
| Comparative | 830 | 75 |
| Example 1 | | |
| Comparative | 828 | 60 |
| Example 2 | | |

From the results listed in Table 1, it is understood that the negative electrode active material has a high discharge capacity and proper cycle characteristics. That is, in Comparative Examples 1 and 2, peeling occurred between the electrode mixture and the current collector as charge-discharge proceeded, so that cycle characteristics were deteriorated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A negative electrode for a nonaqueous electrolyte secondary battery comprising:
a current collector;
a negative electrode active material layer containing a negative electrode active material and a binder that binds the negative electrode active material; and
an azole compound having an amino group as a functional group at a part of an interface between the negative electrode active material layer and the current collector.

2. The negative electrode according to claim 1, wherein the azole compound is present in a range of 5% to 95% of the area of the interface.

3. The negative electrode according to claim 1, wherein the azole compound is present in a range of 5% to 99% of the area of the interface.

4. The negative electrode according to claim 1, wherein the azole compound is a tetrazole compound having an amino group as a functional group.

5. A nonaqueous electrolyte secondary battery comprising a negative electrode,
wherein the negative electrode comprises a current collector, a negative electrode active material layer containing a negative electrode active material and a binder that binds the negative electrode active material, and an azole compound having an amino group as a functional group at a part of an interface between the negative electrode active material layer and the current collector.

6. The secondary battery according to claim 5, wherein the azole compound is present in a range of 5% to 95% of the area of the interface.

7. The secondary battery according to claim 5, wherein the azole compound is present in a range of 5% to 99% of the area of the interface.

8. The secondary battery according to claim 5, wherein the azole compound is a tetrazole compound having an amino group as a functional group.

9. A battery pack comprising a nonaqueous electrolyte secondary battery,
wherein the nonaqueous electrolyte secondary battery comprises a negative electrode,
wherein the negative electrode comprises a current collector, a negative electrode active material layer containing a negative electrode active material and a binder that binds the negative electrode active material, and an azole compound having an amino group as a functional group at a part of an interface between the negative electrode active material layer and the current collector.

10. The battery pack according to claim 9, wherein the azole compound is present in a range of 5% to 95% of the area of the interface.

11. The battery pack according to claim 9, wherein the azole compound is present in a range of 5% to 99% of the area of the interface.

12. The battery pack according to claim 9, wherein the azole compound is a tetrazole compound having an amino group as a functional group.
